(19) United States
(12) Patent Application Publication
(10) Pub. No.: US 2019/0036835 A1
(43) Pub. Date: Jan. 31, 2019

(54) CLIENT SIDE INFORMATION TO INFLUENCE SERVICE LEVEL FOR CLIENT SYSTEM

(71) Applicant: INTERNATIONAL BUSINESS MACHINES CORPORATION, ARMONK, NY (US)

(72) Inventors: Al Chakra, Apex, NC (US); Yuk L. Chan, Rochester, NY (US); Jonathan Dunne, Dungarvan (IE); Liam S. Harpur, Dublin (IE)

(21) Appl. No.: 15/661,554

(22) Filed: Jul. 27, 2017

(51) Int. Cl. H04L 12/911; G06F 9/50; H04L 12/24; H04L 29/06

(52) U.S. Cl. CPC H04L 47/70; H04L 67/42; H04L 41/5019; G06F 9/5027

(57) ABSTRACT

A technique relates to influencing service level management. A client system receives a client module in response to transmitting a request for a workload to a server system. The client module collects client side information associated with a user of the client system and determines a characteristic of the user based on the client side information associated with the user. The client modules determines a service level to be utilized by the server system for the client system based on the characteristic of the user, wherein the service level is for the workload associated with the client system. The client system transmits the service level to the server system.

### BACKGROUND

The present invention generally relates to computer systems, and more specifically, to using client side information to influence service level for client system.

The client server model is a distributed application structure that partitions tasks or workloads between the providers of a resource or service, called servers, and service requesters, called clients. Typically, clients and servers communicate over a computer network on separate hardware, but both client and server may reside in the same system. A server host runs one or more server programs which share their resources with clients. A client does not share any of its resources, but requests a server's content or service function. Clients therefore initiate communication sessions with servers which await incoming requests. Examples of computer applications that use the client server model are email, network printing, online gaming services, and the World Wide Web. In general, a service is an abstraction of computer resources and a client does not have to be concerned with how the server performs while fulfilling the request and delivering the response. The client only has to understand the response based on the well-known application protocol, i.e., the content and the formatting of the data for the requested service. Clients and servers exchange messages in a request response messaging pattern. The client sends a request, and the server returns a response. This exchange of messages is an example of inter-process communication. To communicate, the computers should have a common language, and they should follow rules so that both the client and the server know what to expect.

### SUMMARY

Embodiments of the present invention are directed to a computer-implemented method for influencing service level management. A non-limiting example of the computer-implemented method includes receiving, by a client system, a client module in response to transmitting a request for a workload to a server system, collecting, by the client module, client side information associated with a user of the client system, determining, by the client module, a characteristic of the user based on the client side information associated with the user. The method includes determining a service level to be utilized by the server system for the client system based on the characteristic of the user, where the service level is for the workload associated with the client system, and transmitting the service level to the server system.

Embodiments of the present invention are directed to a client system for influencing service level management. A non-limiting example of the client system includes a processing circuit, and a storage medium readable by the processing circuit and storing instructions that, when executed by the processing circuit, cause the processing circuit to perform a method. A non-limiting example of the method includes receiving, by the client system, a client module in response to transmitting a request for a workload to a server system, collecting, by the client module, client side information associated with a user of the client system, and determining, by the client module, a characteristic of the user based on the client side information associated with the user. Also, the method includes determining a service level to be utilized by the server system for the client system based on the characteristic of the user, where the service level is for the workload associated with the client system, and transmitting the service level to the server system.

Embodiments of the invention are directed to a computer program product for influencing service level management. The computer program product comprising a computer readable storage medium having program instructions embodied therewith, and the computer readable storage medium is not a transitory signal per se. The program instructions are executable by a client system to cause the client system to perform a method. A non-limiting example of the method includes receiving, by the client system, a client module in response to transmitting a request for a workload to a server system, collecting, by the client module, client side information associated with a user of the client system, and determining, by the client module, a characteristic of the user based on the client side information associated with the user. Also, the method includes determining a service level to be utilized by the server system for the client system based on the characteristic of the user, where the service level is for the workload associated with the client system, and transmitting the service level to the server system.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a schematic of an example of a cloud computing node according to embodiments of the present invention;

FIG. 4 depicts an example computer system/server operatively coupled to a client computer system according to embodiments of the present invention;

FIG. 5 depicts a flow chart of client and server operations according to embodiments of the present invention;

FIG. 6 depicts a flow chart of operations performed by the client module according to embodiments of the present invention;

FIG. 7 depicts an example of service level policy rules for a user's sentiment level as a sentiment score according to embodiments of the present invention;

FIG. 8 depicts an example of service level policy rules for a user's sentiment level as a sentiment classification according to embodiments of the present invention; and

FIG. 9 is a flow chart of a computer-implemented method for influencing service level management for the client computer system according to embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number corresponds to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

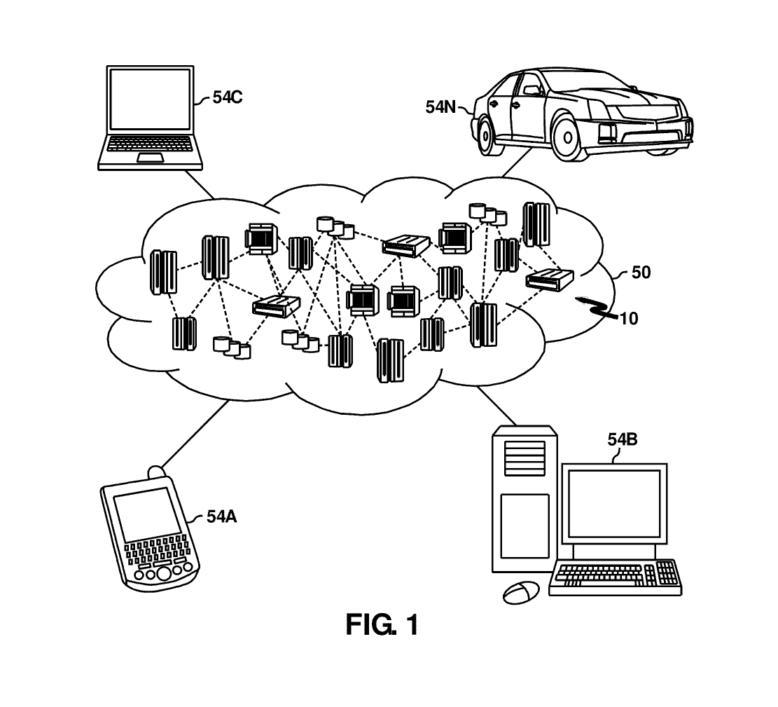

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

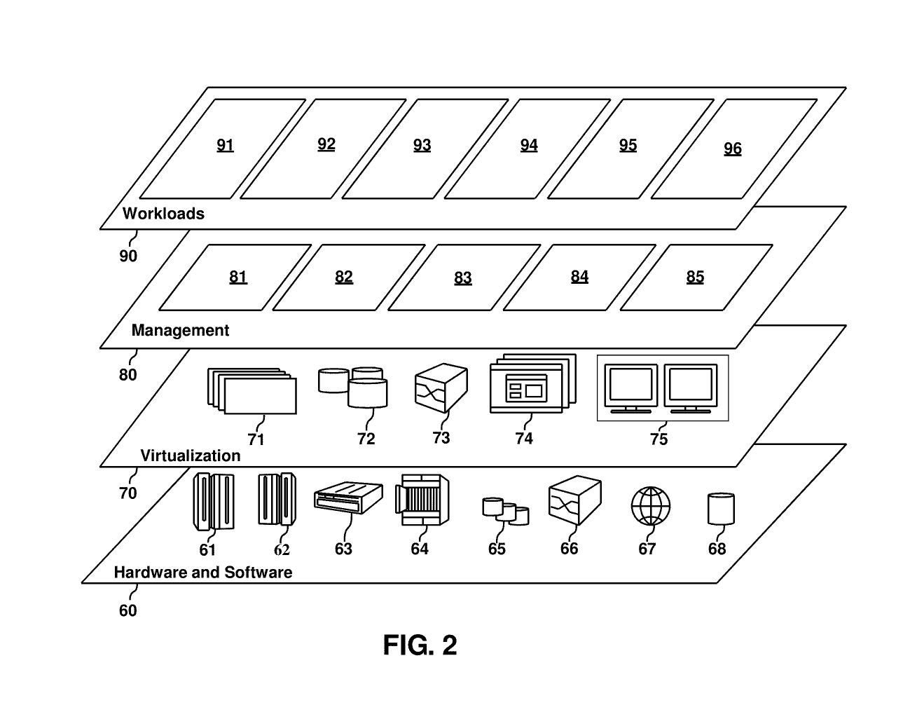

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

Turning now to an overview of technologies that are more specifically relevant to aspects of the invention, servers or server farms (in cloud computing) including workload management (WLM), enterprise workload management, etc., use information provided by the workload (such as login user identification (ID), system name, IP address, etc.) to determine a service level for the workload. For example, 0.5 seconds transaction response time, 50% of a physical processor, and/or a high/low priority, can be done by two mappings:

[ userid: pat* serviceClass: premium ]
[ userid: adam* serviceClass: normal ]

Based on the service level, the WLM will distribute physical resources to the workloads, or select and route workload to available physical resources. This approach is based on meta information related to the workload, including a login user ID for a web application, Enterprise Java Beans (EJB) application name, etc., distribution of the physical resources to the workload does not depend on client side information (according to embodiments of the present invention), which is a lot more dynamic. Often, the client side information is what matters the most for user experience (on the client computer system).

Turning now to an overview of the aspects of the invention, one or more embodiments of the invention address the above-described shortcomings of the prior art by providing a mechanism to distribute a module from the server to a client. This distributed module contains service level agreement and service level determination logic which dynamically determines a service level using client side information that is not available at the server. The client side information can be extrinsic to the transaction itself (i.e., extrinsic to the workload requested/needed by the client). The service level is communicated back to the server from the client and is used for resource management/allocation. In addition, this deployed module also collects information from the client to be provided to the server and used as a feedback loop.

The above-described aspects of the invention address the shortcomings of the prior art by providing technical effects and benefits in which the deployed module collects the data at the client side, and determines the service level at the client side based on this collected client side information. This is a beneficial behavior for privacy and avoids the transfer of a significant amount of (personal) data to the server for service level determination. Technical effects and benefits include determining a service level according to the sentiment (client side information) of the user, thereby changing the allocation of resources (and/or causing the allocation of resources to be changed) at the server side (e.g., in the computing nodes 10 and cloud computing environment 50) for the client in accordance with the sentiment of the user.

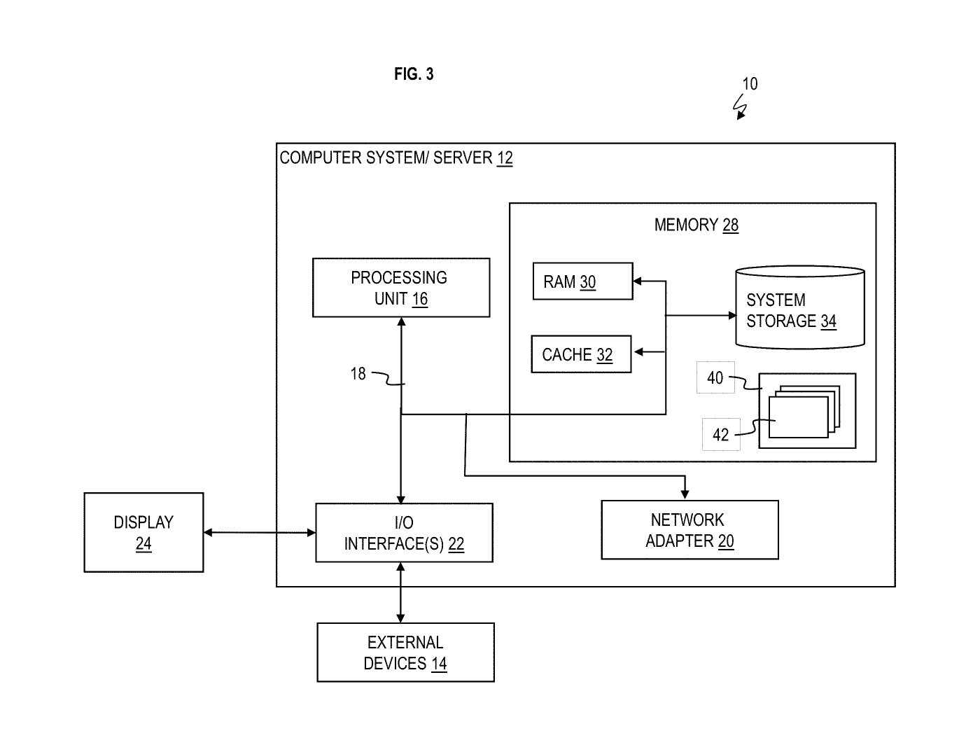

Turning now to a more detailed description of aspects of the present invention, FIG. 3 depicts a schematic of an example of a cloud computing node according to embodiments of the present invention. Cloud computing node 10 is only one example of a suitable cloud computing node and is not intended to suggest any limitation as to the scope of use or functionality of embodiments of the invention described herein.

Regardless, cloud computing node 10 is capable of being implemented and/or performing any of the functionality set forth hereinabove. In cloud computing node 10 there is a computer system/server 12, which is operational with numerous other general purpose or special purpose computing system environments or configurations.

Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. Memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Further, the computer system/server 12 may include, be integrated with, and/or be coupled to elements in hardware and software layer 60, virtualization layer 70, management layer 80, and workloads layer 90.

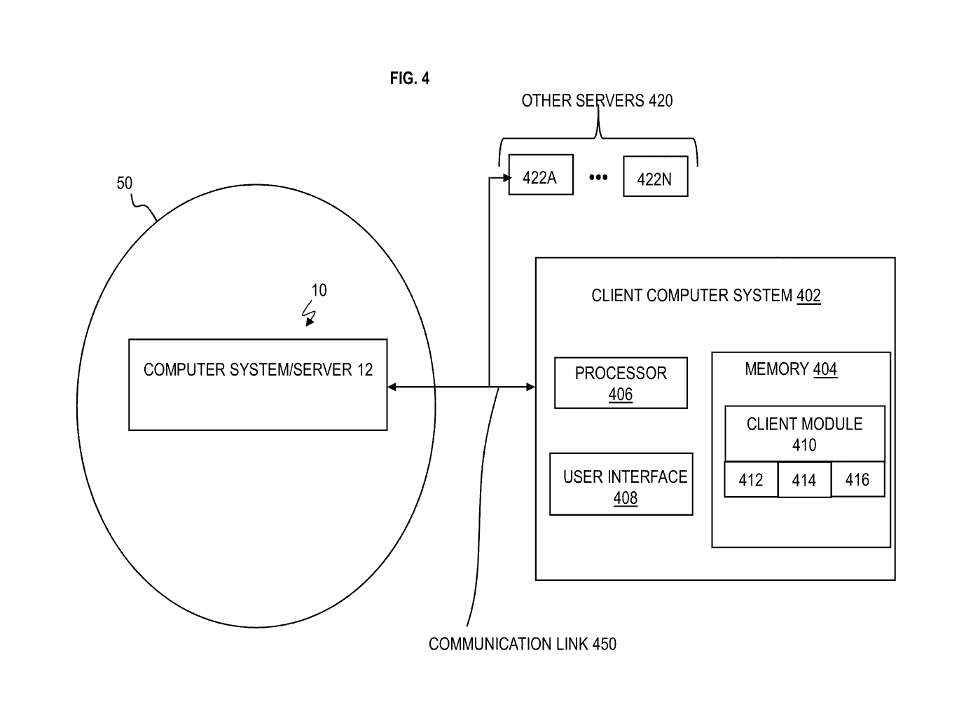

FIG. 4 depicts an example computer system/server 12 operatively connected to a client computer system 402 according to embodiments of the present invention. The client computer system 402 can be representative of any type of local computing devices used by cloud consumers including any of example computing devices 54A-N discussed above. The client computer system 402 includes memory 404, processors 406 (including processing circuits), user interfaces 408 such as a keyboard, mouse, touch screen, etc.

The client computer system 402 can connect to the server computer system 12 via a communication link 450. The communication link may include wire and wireless communication networks through which communication signals can be transmitted back and forth as understood by one skilled in the art. The client computer system 402 can connect to other servers 420, which can be servers 422A-N. The other servers 420 can provide and host services personal to the user of the client computer system 402. The hosted servers 420 can include and be representative of social media websites/servers of the user (such as, for example, Facebook®, Twitter®, Instagram®, Pinterest®, etc.), electronic messaging websites/servers (such as, for example, Gmail®, Hotmail®, etc.), video websites/servers and streaming movie providers (such as, for example, YouTube®, Netflix®, Amazon® Video, etc.), retailer websites (Amazon®, flower shops), memorial services, grieving services, etc. Some of the services provided by the other server 420 may overlap.

The memory 404 can include a client module 410 which is utilized, for example, to collect client side information on the client computer system 402 in order to determine the user's sentiment. For example, a user (operating client computer system 402) that is in a bad mood can be provided a higher service level from the server computer system 12 on computer node 10, while a user that is in a good mood can be given a normal service level (or lower service level). This will ensure satisfaction for a user that is easily dissatisfied or frustrated. This is technical change in how the server computer system 12 receives a service level (and how the service level is determined) such that the server computer system 12 responds faster to the workload of the client computer system 402 of the user having a low/negative sentiment (than for a normal/neutral sentiment or positive sentiment) because the client module 410 has determined that a high service level is to be given for the user having a negative sentiment (i.e., in a bad mood).

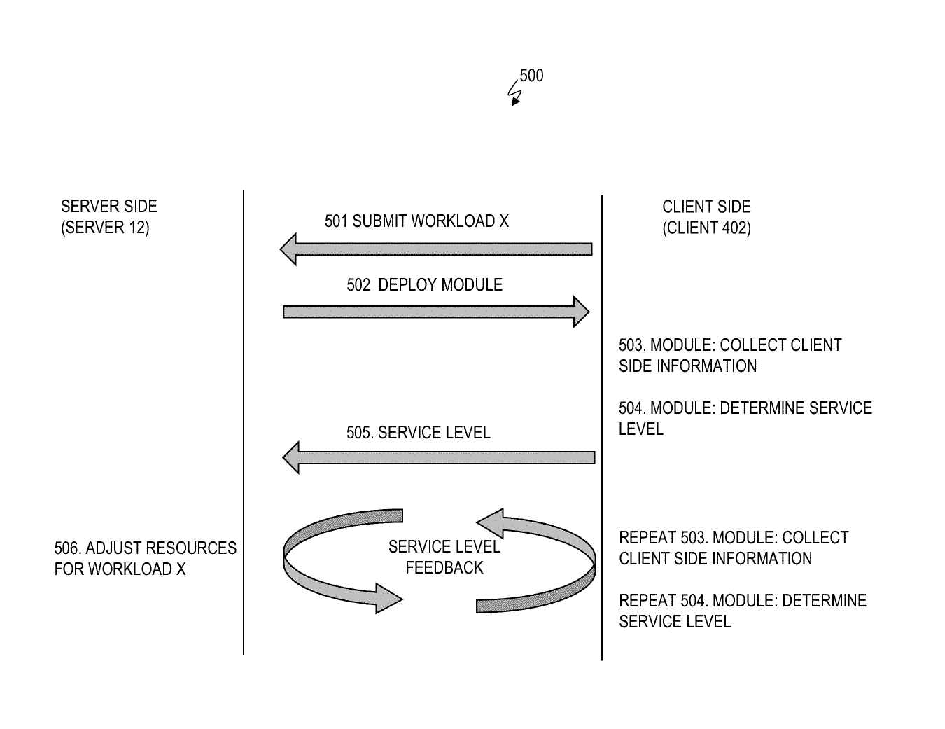

An example scenario is provided below in which client side information is utilized by the client module 410 to determine the service level for the client computer system 402 of the user, instead of the server 12 determining the service level. FIG. 5 depicts a high level flow chart 500 of client and server operations and data flow according to embodiments of the present invention.

At block 502, the client computer system 402 is configured to submit a workload to the server computer system 12. There can be many different example workloads. For example, transmitting the workload can occur by the user of client system 402 accessing a Uniform Resource Locator (URL), selecting information on a purchase or potential purchase, accessing music from the server, accessing video, etc. The server system 12 receives a request to process the workload from the client 402.

In response to receiving request to process the workload, the server 12 is configured to deploy the client module 410 to the client 402. The client module 410 is transmitted from the server 12 (or a designated server) to the client 402. The client module 410 can be a client side script designed to operate on the client computer system 402. Examples of the client module 410 (sent from the server 12) can include a plugin for the browser (of client 402), an application on a smart phone (client 402), a client side Javascript® (on client 402), a Java class downloaded and run in an application on the client 402, a module (on the client 402) that collects information from an external device connected through Bluetooth®, etc. The client 402 may have to explicitly accept the client module 410 and/or the client 402 may have previously given permission for such client modules 410 (from the server 12) to operate on the client computer system 402. Client access right might have to be granted data to the client module 410, and/or the client module 410 can inherit access right from the client 402. The data access right can be the right to access an application, the right to use user's credential to access APIs on the local system and/or remote servers (including servers 420, etc.), the right to access storage, the right to access hardware such as camera and audio input, etc.

At block 503, the client module 410 is configured to collect client side information via client computer system 402. The client side information is associated with the user of the client computer system 402. The client module 410 can assign a sentiment class and/or sentiment score to the user based on the collected client side information.

At block 504, the client module 410 is configured to determine the service level for the client computer system 402 based on the collected client side information. For example, then the sentiment of the user is determined to be low/negative (which can be in a predefined low/negative class or be a predefined low/negative score), the client module 410 is configured to assign a high service level to the client 402. The client module 410 of the client system 402 is configured to send the service level (determined for the client system 402) to the server system 12.

At block 506, the server system 12 is configured to adjust resources for the (requested) workload based on the service level received from the client module 410 of the client 402. A high service level receives more resources such as more processors, more allocated memory, more cache, faster processors, faster cache, etc., than a normal service level or a low service level. For example, the server 12 can include the service level management 84 and/or be coupled to the service level management 84 such that the service level management 84 allocates more resources for a service level that is high (i.e., determined from a low/negative sentiment of the user) as opposed to allocating fewer resources for a service level that low (determined from a high/positive sentiment of the user) or medium/normal (determined from a neutral/normal sentiment of the user).

As subsequent workloads continue to be processed by the server system 12 for the client system 402, the process of blocks 503 and 504 (and block 505) repeat for the client module 410, thereby continuously providing the up-to-date service level determined at the client 402. This continuously determined service level can be changed based on the updated client side information. In the example in which the client's emotion has changed based on service received by the submitted work, this continuously provided service level behaves as a service feedback loop. Similarly, block 506 repeats for the server system 12 according to any change in the service level sent by the client module 410. Additionally, as the subsequent workloads are processed by the server 12, the subsequent workloads will continue to be processed with the same service level previously determined unless a new service level is determined in the feedback loop (blocks 503, 504, 505, and 506).

In some embodiments of the present invention, the client system 402 can connect to a webpage of a server (such as the server 12). When the webpage is loaded from the server to the client, a client module 410 can also be loaded onto the client 402. Through this webpage, a user on the client system can submit work to the server. While the client submits the work, the process of block 503, 504 and 505 will collect client side information, determine service level, and send the determined service level to the server 12.

In some embodiments of the present invention, the workload can be a long running workload. Client module 410 can provide updated service level periodically. When the server 12 receives the updated service level, server 12 can change resources allocated to the workload (running on behalf of the client 402). The updated service level will continuously and periodically send to the server until the workload is completed.

In some embodiments of the present invention, an updated client module (e.g., newer (version of) client module 410) can be deployed and replace the existing module at the client side. This updated client module (410) can collect different information compared to the original client module. This new module could trigger requests for new access rights on the client 402.

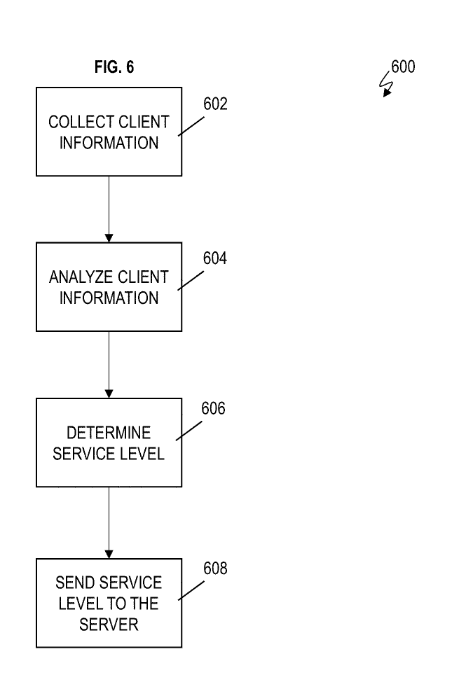

As further details of the client module 410, FIG. 6 depicts a flow chart 600 of operations performed by the client module 410 according to embodiments of the present invention. At block 602, the client module 410 is configured to collect client information via the client computer system 402. For example, the client module 410 can be an application (that has requested permission from the user to access a social media application/network of other servers 420, such as Facebook®. Accordingly, the client module 410 is configured to collect the Facebook post associated with the user (as client side information after receiving permission). Various social media websites are represented by the other servers 420 (individually represented by servers 42A-N), and the client module 410 is configured to access the social media websites associated with the user of client system 402. In another example, the client module 410 is configured to access user heart rate from a fitness and exercise device (such as a Fitbit® device) through a wireless radio connection (such as a Bluetooth® connection). Permission could have been given by the user in advance and/or in the past from previous interactions with the services provided by the server computer 12 (computer node 10 and/or cloud computer system 50). Additionally, the client module 410 can be an application that monitors the user's interaction with user interfaces, such as a touch screen, mouse, keyboard, and/or tactile device. Further, the client module 410 is configured to access media in the storage (memory 404 or other memory) of the client computer system 402 of the user, and the media might be recent photos, recent videos, recent movies, and recent music. Recent media means that the media has be recently stored, purchased, created, watched, listened to, accessed, captured (for pictures, video) by the client system 402. Recent is a predefined time period which can be 10 hours, 24 hours, 36 hours, and/or 48 hours.

At block 604, the client module 410 is configured to analyze the client side information to determine to the sentiment of the user. The sentiment describes the mood and attitude of the user based on the collected client side information. Sentiment analysis (sometimes known as opinion mining or emotion artificial intelligence) refers to the use of natural language processing, text analysis, computational linguistics, and biometrics to systematically identify, extract, quantify, and study affective states and subjective information. Sentiment analysis is widely applied to the voice of the customer materials such as reviews and survey responses, online and social media. Sentiment analysis aims to determine the attitude of a speaker, writer, or other subject with respect to some topic or the overall contextual polarity or emotional reaction to a document, interaction, or event. The attitude may be a judgment or evaluation, affective state (that is to say, the emotional state of the author or speaker), and/or the intended emotional communication (that is to say, the emotional effect intended by the author or interlocutor). A basic task in sentiment analysis is classifying the polarity of a given text at the document (and/or media), sentence, and/or feature/aspect level to determine whether the expressed opinion in a document, a sentence and/or an entity feature/aspect is positive, negative, or neutral. The sentiment analysis is also configured to advance “beyond polarity” such that sentiment classification looks, for instance, at emotional states such as “angry”, “sad”, and “happy”.

Even though in most statistical classification methods, the neutral class is ignored under the assumption that neutral texts lie near the boundary of the binary classifier, embodiments can have three categories identified for the polarity and have classifiers (such as the Max Entropy and the support vector machines) which include a neutral class. There are in principle two ways for operating with a neutral class. Either, the algorithm proceeds by first identifying the neutral language, filtering it out, and then assessing the rest in terms of positive and negative sentiments, or it builds a three-way classification in one step. This second approach often involves estimating a probability distribution over all categories (e.g., naive Bayes classifiers as implemented by a natural language toolkit by Python™). Whether and how to use a neutral class depends on the nature of the data: if the data is clearly clustered into neutral, negative, and positive language, embodiments can filter the neutral language out and focus on the polarity between positive and negative sentiments.

A different method for determining sentiment is the use of a scaling system whereby words (and/or media) commonly associated with having a negative, neutral, or positive sentiment with them are given an associated number on a −10 to +10 scale (most negative up to most positive) or simply from 0 to a positive upper limit such as +4. This makes it possible to adjust the sentiment of a given term relative to its environment (usually on the level of the sentence). When a piece of unstructured text is analyzed using natural language processing, each concept in the specified environment is given a score based on the way sentiment words relate to the concept and its associated score. Additionally, texts (and/or media) can be given a positive and negative sentiment strength score if the goal is to determine the sentiment in a text rather than the overall polarity and strength of the text.

It should be appreciated that there are many ways to detect sentiment, and embodiments are not meant to be limited. Embodiments can incorporate any known technique in the state-of-the-art to determine sentiment as understood by one skilled in the art.

In some embodiments of the present invention, block 604 can determine if a user has complained about the service provided by the server 12. These complaint can be determined from Twitter tweets, Facebook posts, etc., which have been accessed by the client module 410. These posts do not necessarily mean the user has a negative emotion, but it can be simply a statement such as “still waiting for the job to finish”. This can be utilized by the client module 410 to increase the service level for the user of the client 402. In general, any information can be used to determine service level in block 604.

Continuing the example scenario, the client module 410 is configured analyze the recent social media posts (recent Facebook post) to determine if the recent social media posts show that the user is happy (positive sentiment), sad (negative sentiment), and/or normal mood (neutral sentiment). The text and/or media of the social media web site (Facebook) and/or storage on the client system 402 is analyzed (parsed) by the client module 410. Any text having negative words predefined as associated with a negative mood is classified (by the client module 410) as a negative sentiment and/or a negative score (e.g., −10). Similarly, any media (pictures, video, etc.) predefined as being associated with a negative mood is classified (by the client module 410) as a negative sentiment and/or a negative score (e.g., −10). Analogously, any text and/or media having been predefined as neutral or normal sentiment is classified by the client module 410 as neutral sentiment and/or a neutral score (e.g., 0). Likewise, any text and/or media having been predefined as being associated with a positive mood is classified by the client module 410 as a positive sentiment and/or positive score (e.g., 10).

Media (including pictures, video, caption of media, a voice, etc.) in the storage (memory 404) and/or social media network/websites (other servers 420) associated with a traumatic experience and/or saddened experience is classified by the client module 410 as negative sentiment and/or negative score (e.g., −10). Examples of traumatic experiences and/or saddened experiences may include hospitalization media, memorial service media (such as a loss in the family, loss of a friend, etc. which can be determined by tags or a caption), emergency related media, etc.; such media is utilized by the client module 410 to classify the user as having a negative sentiment and/or negative score (e.g., −10).

Also, the client module 410 is configured to check whether the user shows frustration, for example, by repeatedly clicking the mouse, pressing enter, etc., and if so, the client module 410 is configured to classify these types of actions as a negative sentiment and/or a negative score (e.g., −10).

The user's sentiment level can be a positive sentiment, neutral sentiment, and/or negative sentiment, and the client module 410 can store the user's sentiment level as sentiment 412 (e.g., user characteristic). In some implementations, the user's sentiment level can be a sentiment score which is averaged by the client module 410. The client module 410 can assign +10 for positive client side information, −10 for negative client side information, and 0 for neutral client side information. The client module 410 can average the assigned values of the client side information to obtain the user's sentiment level. In some implementations, the client module 410 gives more weight to negative client side information (whether using a score or classification). After averaging the assigned values/scores for the positive client side information, negative client side information, and neutral client side information, the client module 410 has a sentiment level for the user. The positive sentiment, neutral sentiment, and/or negative sentiment each can represent predefined values such that the averaged value will fall into one of the predefined values.

At block 606, the client module 410 is configured to determine the service level that should be applied to the client computer system 402. Using the user's sentiment level 412 as input, the client module 410 is configured to determine and store the service level 414. The service level 414 can be a low service level, a high service level, or a normal service level. The client module 410 can have service level policy rules 416 to determine the service level 414 of the client system 402 based on the user's sentiment level 412.

It is noted that a low service level has more delay in providing responses (for workloads) back to the client system 402 from the server system 12 than a medium service level. A medium service level has more delay in providing responses (for workloads) back to the client system 402 from the server system 12 than a high service level. A high service level provides the fastest response back to the client 402 because more resources are utilized to perform the workload. In one case, a high service level is assigned by the client module 410 to the client system 402 to account for the determined negative sentiment.

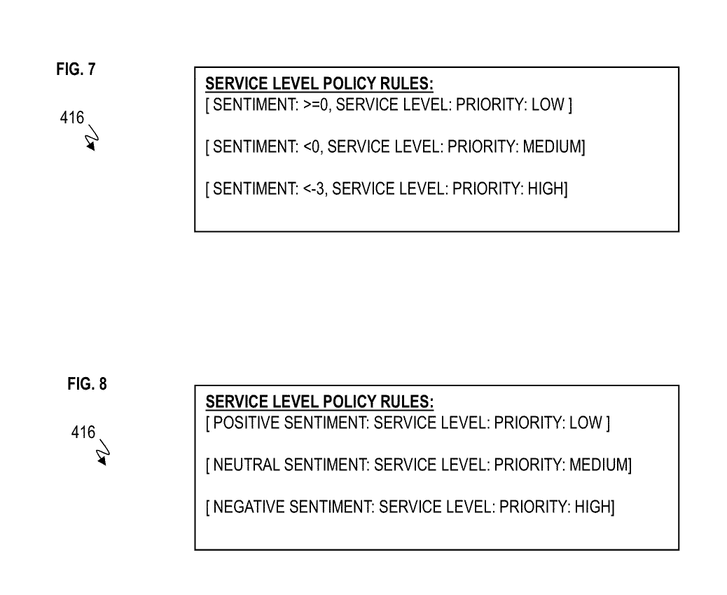

FIG. 7 depicts an example of service level policy rules 416 for a user's sentiment level 412 as a sentiment score. FIG. 8 depicts an example of service level policy rules 416 for a user's sentiment level 412 as a sentiment classification. Regardless of the type of sentiment level 412 used, the client module 410 is configured to determine a high service level when the user is in a negative sentiment (bad mood), and determine a low service level when the user is in a positive sentiment (happy mood).

Returning to FIG. 6, at block 608, the client module 410 is configured to cause the client system 402 to send the service level 414 (high, medium, or low) to the server system 12, such that the service level 414 can be applied by the server 12 (including the computer node 10 and/or cloud computing environment 50) on behalf of the client computer system 402. As one option to send the service level 414 to the server 12, the client module 410 may embed the service level in an HTTP header in an HTTP request and then send HTTP request to the server 12. Other options may include a control message including both the service level, the workload identifier or user's identifier; separately, another message containing the workload identifier and the details of the workload can be sent to the server. The control message can be sent using any protocol, including HTTP, HTTPS, or proprietary protocols. In some embodiments of the present invention, the control message can provide the client IP address, reason for determined service level, etc.

For privacy, the client module 410 can be configured to only send the service level 414 back to server 12 but does not send any client side information that has been collected. Additionally, the client module 410 does not send client side information off the client system 402 to computer systems. The operations to determine the service level 414 are performed by the client module 410 on the client system 402. Therefore, the user's privacy is maintained by having the client module 410 function on the client system 402.

In some implementations, the client module 410 may be configured to expire after a predetermined time and/or after number of uses so that it is no longer operable. This prevents the client module 410 from operating at without the user's knowledge.

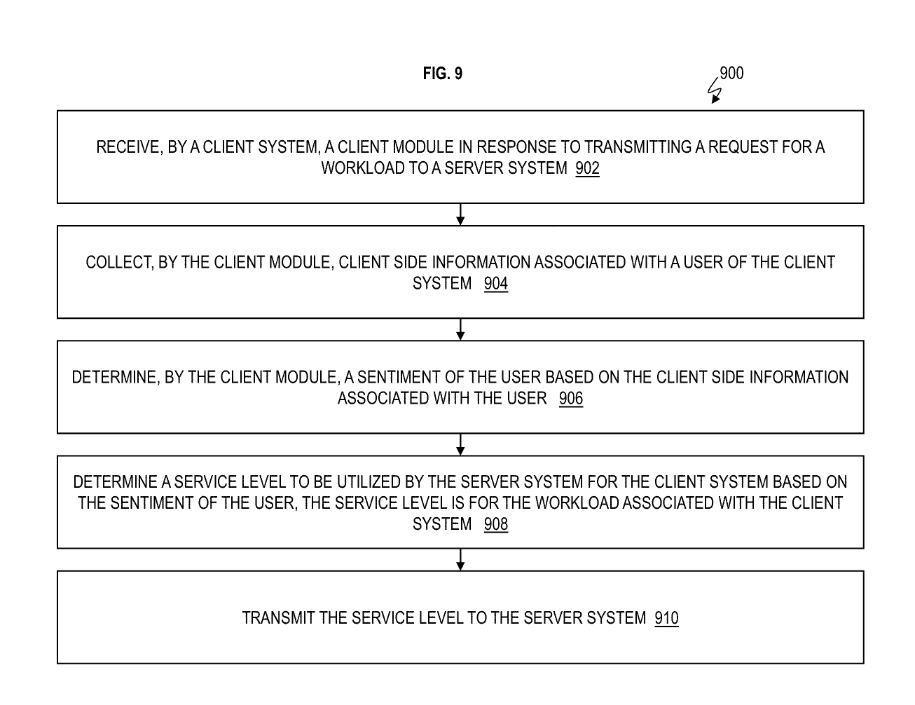

FIG. 9 is a flow chart 900 of a computer-implemented method for influencing service level management for the client computer system 402 according to embodiments of the present invention. Reference can be made to the figures discussed herein.

At block 902, the client system 402 is configured to receive a client module 410 in response to transmitting a request for a workload to a server system 12. At block 904, the client system 402 is configured to collect client side information associated with a user of the client system 402. At block 906, the client system 402 is configured to determine a user characteristic (e.g., sentiment 412) of the user based on the client side information associated with the user.

At block 908, the client system 402 is configured to determine a service level 414 to be utilized by the server system 12 for the client system 402 based on the user characteristic (sentiment 412) of the user, where the service level 414 is for the workload associated with the client system 402. The workload can be the representative of a more than on workload such as a sequence of workloads in a session. A session can be a music session, video session, purchase session, search session, etc. being performed by the client system 402 in which the server 12 is providing a service.

At block 910, the client system 402 is configured to transmit the service level 414 to the server system 12.

The workload is to be performed by the server system 12. Determining (by the client module 410), the sentiment of the user based on the client side information associated with the user comprises assigning a sentiment value 412.

Assigning the sentiment value 412 comprises: assigning, by the client module, a first value for a positive type of the client side information, assigning, by the client module, a second value for a neutral type of the client side information, and assigning, by the client module, a third value for a negative type of the client side information. The client module 410 is configured to determine that the service level is low when the sentiment value is a first value (e.g., >=0), determine that the service level is medium when the sentiment value is a second value (e.g., <0 but not less than the third value), and determine that the service level is high when the sentiment value is a third value (e.g., <−3).

The service level is determined (by the client module 410) to be high based on the sentiment of the user being a low value/score, determined to be medium based on the sentiment of the user being a medium value, and determined to be low based on the sentiment of the user being a high value. The medium value is greater than the low value, and the high value is greater than the medium value.

The client module 410 is configured to determine a high level as the service level 414 in response to the sentiment 412 being negative for the user. The service level that is the high level allocates (and/or is designed to require the allocation of) more computing resources that a low level.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for influencing service level management, the method comprising:
receiving, by a client system, a client module in response to transmitting a request for a workload to a server system;
collecting, by the client module, client side information associated with a user of the client system;
determining, by the client module, a characteristic of the user based on the client side information associated with the user;
determining a service level to be utilized by the server system for the client system based on the characteristic of the user, wherein the service level is for the workload associated with the client system; and
transmitting the service level to the server system.

2. The computer-implemented method of claim 1, wherein the workload is to be performed by the server system.

3. The computer-implemented method of claim 1, wherein determining the characteristic, by the client module, the characteristic of the user based on the client side information associated with the user comprises assigning a sentiment value.

4. The computer-implemented method of claim 3, wherein assigning the sentiment value comprises:
assigning, by the client module, a first value for a positive type of the client side information;
assigning, by the client module, a second value for a neutral type of the client side information; and
assigning, by the client module, a third value for a negative type of the client side information.

5. The computer-implemented method of claim 4, wherein the client module is configured to determine that the service level is low when the sentiment value is the first value, determine that the service level is medium when the sentiment value is the second value, and determine that the service level is high when the sentiment value is the third value.

6. The computer-implemented method of claim 1, wherein the service level is determined to be high based on the characteristic of the user being a low value;
wherein the service level is determined to be medium based on the characteristic of the user being a medium value; and
wherein the service level is determined to be low based on the characteristic of the user being a high value.

7. The computer-implemented method of claim 1, wherein the client module is configured to determine a high level as the service level in response to the characteristic being negative for the user; and
wherein the service level that is the high level allocates more computing resources that a low level.

8. A computer program product for influencing service level management, the computer program product comprising a computer readable storage medium having program instructions embodied therewith, wherein the computer readable storage medium is not a transitory signal per se, the program instructions readable by a client system to cause the client system to perform a method comprising:
receiving, by the client system, a client module in response to transmitting a request for a workload to a server system;
collecting, by the client module, client side information associated with a user of the client system;
determining, by the client module, a characteristic of the user based on the client side information associated with the user;
determining a service level to be utilized by the server system for the client system based on the characteristic of the user, wherein the service level is for the workload associated with the client system; and
transmitting the service level to the server system.

9. The computer program product of claim 8, wherein the workload is to be performed by the server system.

10. The computer program product of claim 8, wherein determining characteristic, by the client module, the characteristic of the user based on the client side information associated with the user comprises assigning a sentiment value.

11. The computer program product of claim 10, wherein assigning the sentiment value comprises:
assigning, by the client module, a first value for a positive type of the client side information;
assigning, by the client module, a second value for a neutral type of the client side information; and
assigning, by the client module, a third value for a negative type of the client side information.

12. The computer program product of claim 11, wherein the client module is configured to determine that the service level is low when the sentiment value is the first value, determine that the service level is medium when the sentiment value is the second value, and determine that the service level is high when the sentiment value is the third value.

13. The computer program product of claim 8, wherein the service level is determined to be high based on the characteristic of the user being a low value;
wherein the service level is determined to be medium based on the characteristic of the user being a medium value; and
wherein the service level is determined to be low based on the characteristic of the user being a high value.

14. The computer program product of claim 8, wherein the client module is configured to determine a high level as the service level in response to the characteristic being negative for the user; and
wherein the service level that is the high level allocates more computing resources that a low level.

15. A client system for influencing service level management, the client system comprising:
a processing circuit; and
a storage medium readable by the processing circuit and storing instructions that, when executed by the processing circuit, cause the processing circuit to perform a method comprising:
receiving, by the client system, a client module in response to transmitting a request for a workload to a server system;
collecting, by the client module, client side information associated with a user of the client system;
determining, by the client module, a characteristic of the user based on the client side information associated with the user;
determining a service level to be utilized by the server system for the client system based on the characteristic of the user, wherein the service level is for the workload associated with the client system; and
transmitting the service level to the server system.

16. The client system of claim 15, wherein the workload is to be performed by the server system.

17. The client system of claim 15, wherein determining, by the client module, the characteristic of the user based on the client side information associated with the user comprises assigning a sentiment value.

18. The client system of claim 17, wherein assigning the sentiment value comprises:
assigning, by the client module, a first value for a positive type of the client side information;
assigning, by the client module, a second value for a neutral type of the client side information; and
assigning, by the client module, a third value for a negative type of the client side information.

19. The client system of claim 18, wherein the client module is configured to determine that the service level is low when the sentiment value is the first value, determine that the service level is medium when the sentiment value is the second value, and determine that the service level is high when the sentiment value is the third value.

20. The client system of claim 15, wherein the service level is determined to be high based on the characteristic of the user being a low value;
wherein the service level is determined to be medium based on the characteristic of the user being a medium value; and
wherein the service level is determined to be low based on the characteristic of the user being a high value.
